(19) United States
(12) Patent Application Publication
(10) Pub. No.: US 2005/0095454 A1
(43) Pub. Date: May 5, 2005

(54) [ORGANIC ELECTRO-LUMINANCE DEVICE AND FABRICATING METHOD THEREOF]

(76) Inventors: Chung-Wen Ko, Taipei County (TW); Fan-Hsiu Chang, Miaoli County (TW); Wen-Kuen Chen, Hsinchu (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/707,868

(22) Filed: Jan. 20, 2004

(30) Foreign Application Priority Data
Oct. 30, 2003 (TW) 92130174

(51) Int. Cl. H05B 33/14

(52) U.S. Cl. 428/690; 428/917; 313/504; 313/506; 427/66

(57) ABSTRACT

An organic electroluminescent device is disclosed. The organic electroluminescent device comprises a substrate, an anode, a blue luminescent layer, and a cathode. The anode is disposed on the substrate. The blue luminescent layer is disposed on the anode. The cathode is disposed on the luminescent layer. The blue luminescent layer comprises a host, a first dopant and a second dopant. The first dopant and the second dopant are doped within the host. Because of the excellent blue light color and brightness of first dopant in blue luminescent layer and the longer lifetime of second dopant in blue luminescent layer, the organic electroluminance device of the present invention improves lifetime, luminescent efficiency, and brightness thereof.

### CROSS REFERENCE TO RELATED APPLICATIONS

This application claims the priority benefit of Taiwan application serial no. 92130174, filed Oct. 30, 2003.

### BACKGROUND OF INVENTION

1. Field of the Invention

The present invention relates to an organic electroluminance device and a fabricating method thereof, and more particularly to an organic electroluminance device and a fabricating method thereof for improving luminescent efficiency, lifetime and brightness thereof.

2. Description of the Related Art

Computer, communication and consumer products have become the main trend of high technology. Portable electronic devices are also the essential products of development. Of course, displays are also included. To date, displays includes: Organic Electroluminance Display (OELD), Plasma Display Panel (PDP), Liquid Crystal Display (LCD), Light Emitting Diode Display, Vacuum Fluorescent Display, Field Emission Display (FED) and Electrochromic Display. Compared with these displays, the organic electro-luminance display, however, has advantages of self-luminance, no view angle dependence, low power consumption, simple manufacturing process, low cost, low operation temperature range, high response speed and high full color resolution etc. Accordingly, the organic electro-luminance display has potential applications and can become the main trend for the next generation displays.

The organic electro-luminance device performs display by using organic luminescent material. The structure includes two electrodes and an emitting layer (EMT) between the electrodes. When a voltage is applied to the diode, holes from the anode recombine with electrons form the cathode within the emitting layer for generating excitons. From the use of different properties of materials, different color lights can be generated. It is the basic principle of electro-luminescence. In order to improve the luminescent efficiency of the organic electroluminescent device, the organic luminescent layer is formed by vacuum evaporation. Following is a description of a prior art organic electro-luminescent device.

FIG. 1 is a schematic cross-sectional view of a prior art organic electro-luminance device. Referring to FIG. 1, the prior art organic electro-luminescent device 100 includes a substrate 110, an anode 120 formed thereon, a luminescent layer 130 formed on the anode 120 and a cathode 140 formed on the luminescent layer 130. Moreover, a cover plate 160 is formed on the cathode 140 for packaging the organic electro-luminescent device 100.

In order to generate blue light from the organic electro-luminescent device 100, the luminescent layer 130 is a blue luminescent layer 132. The prior art blue luminescent layer 132 is composed of a host and a dopant. Because of poor combination of the host and the dopant, morphology of the blue luminescent layer 132 is unstable and the quality of the blue luminescent layer 132 will decay. Moreover, the interface of the blue luminescent layer 132 and the other material has some problems which results in the increase of the driving voltage of the organic electroluminescent device 100 and reduction of the lifetime thereof.

In order to emit white light from the prior art organic electroluminescent device 100, the luminescent layer 130 usually is composed of a blue luminescent layer 132 and an orange-red luminescent layer 134. Therefore, white light is generated by the complementary color of the blue and orange-red lights. However, as described above, because of poor combination of the host and the dopant, the morphology of the blue luminescent layer 132 is unstable and the quality of the blue luminescent layer 132 will decay. Accordingly, chromatic aberration occurs within the organic electroluminescent device 100.

### SUMMARY OF INVENTION

Accordingly, an object of the present invention is to provide an organic electroluminescent device and a fabricating method thereof, which are adapted to use two dopants inblue luminescent layer for improving emitting luminescent efficiency, lifetime and brightness thereof.

In accordance with the above object, the present invention provides an organic electroluminescent device, comprising a substrate, an anode, a cathode and a blue luminescent layer. The anode is on a substrate; the blue luminescent layer is on the anode layer; and the cathode is on the blue luminescent layer.

The blue luminescent layer comprises: a host, a first dopant and a second dopant. The first and second dopants are doped within the host. The light wavelength generated by the second dopant is different from the light wavelength generated by the first dopant.

Additionally, the first dopant within the blue luminescent layer is more than the second dopant by weight percentage. The first dopant within the blue luminescent layer is from about 0.01% to about 50% by weight which generates light having a peak wavelength from about 400 nm to about 470 nm. The second dopant within the blue luminescent layer is from about 0.01% to about 50% by weight which generates light having a peak wavelength from about 420 nm to about 490 nm.

In addition, an absorption wavelength of the second dopant is shorter than an emitting wavelength of the first dopant. The first dopant can be, for example, amino substituted distyrylarylene. The second dopant can be, for example, perylene compound.

Additionally, the organic electroluminescent device further comprises an orange-red luminescent layer between the anode and the blue luminescent layer, or between the cathode and the blue luminescent layer.

The present invention also provides a method of fabricating an organic electroluminescent device. The method comprises: forming an anode on a substrate; forming a blue luminescent layer on the anode; and forming a cathode on the blue luminescent layer.

Moreover, the blue luminescent layer comprises: a host, a first dopant and a second dopant. The first and second dopants are doped within the host. The light wavelength generated by the second dopant is different from the light wavelength generated by the first dopant.

Additionally, the first dopant within the blue luminescent layer is more than the second dopant by weight percentage. The first dopant within the blue luminescent layer is from about 0.01% to about 50% by weight which generates light having a peak wavelength from about 400 nm to about 470 nm. The second dopant within the blue luminescent layer is from about 0.01% to about 50% by weight which generates light having a peak wavelength from about 420 nm to about 490 nm.

In addition, an absorption wavelength of the second dopant is shorter than an emitting wavelength of the first dopant. The first dopant can be, for example, amino substituted distyrylarylene. The second dopant can be, for example, perylene compound.

Additionally, the organic electroluminescent device further comprises an orange-red luminescent layer between the anode and the blue luminescent layer, or between the cathode and the blue luminescent layer.

Accordingly, the organic electro-luminance device and the fabricating method thereof of the present invention uses two dopants intheblue luminescent layerwhich include improving the blue light brightness and luminescent efficiency by using the first dopant, and improving the lifetime by using the second dopant. Moreover, the organic electroluminescent device further uses an orange-red luminescent layer to generate white light and reduce the chromatic aberration of the white light.

In order to make the aforementioned and other objects, features and advantages of the present invention understandable, a preferred embodiment accompanied with figures is described in detail below.

### BRIEF DESCRIPTION OF DRAWINGS

FIG. 1 is a schematic cross-sectional view of a prior art organic electroluminescent device.

FIG. 2 is a schematic cross-sectional view showing an organic electroluminescent device according to a first preferred embodiment of the present invention.

FIG. 3 is a comparison of voltage-time relationship of the organic electroluminescent devices with a single dopant and two dopants intheblue luminescent layer thereof.

FIGS. 4A-4K are structures of the host, the first dopant and second dopant that are preferably used for doping blue luminescent layer of the organic electroluminescent device of the present invention.

FIGS. 5A and 5B are schematic cross-sectional views showing an organic electroluminescent device according to a second preferred embodiment of the present invention.

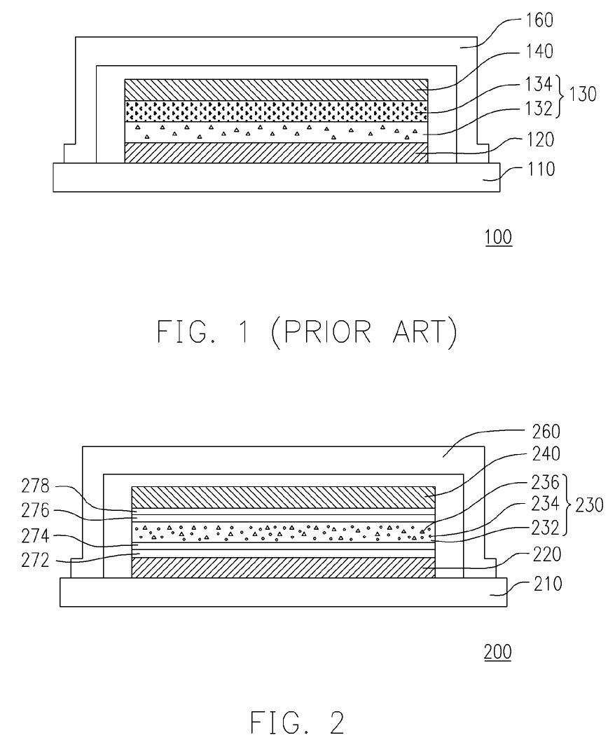

### DETAILED DESCRIPTION

FIG. 2 is a schematic cross-sectional view showing the first preferred organic electroluminescent device of the present invention. Referring to FIG. 2, the organic electroluminescent device 200 comprises a substrate 210, an anode 220, a blue luminescent layer 230 and a cathode 240. The substrate 210 can be, for example, a glass substrate, a plastic substrate or a flexible substrate. The anode 220 is on the substrate 210. Because the anode 220 serves injecting holes into the blue luminescent layer 230, the anode 210 is a preferred material having a high work function. The anode 210 can be, for example, indium tin oxide (ITO), tin oxide, gold, silver, platinum, nickel, chromium, molybdenum or copper. The blue luminescent layer 230 is on the anode layer 220. The cathode 240 is on the blue luminescent layer 230, which serves for injecting electrons thereto. The cathode 240 can be, for example, a single conductive layer having low work function, such as lithium, magnesium, calcium, aluminum or silver. The cathode 240 can also be, for example, a double layer conductive layer, such as LiF/Al, Be/Al, Mg/Ag, etc.

Furthermore, the blue luminescent layer 230 comprises: a host 232, a first dopant 234 and a second dopant 236. The first and second dopants 234 and 236 respectively are doped within the host 232. The light wavelength generated by the second dopant 236 is different from the light wavelength generated by the first dopant 234.

The light generated from the combination of the host 232 and the first dopant 234 has a short wavelength, so the blue light brightness and luminescent efficiency are improved after the light passes through a color filter. Although the blue light generated from the combination of the host 232 and the second dopant 236 is weak, they can generate the light having long lifetime and stabilize the conjunction of the blue luminescent layer 230 with the other material.

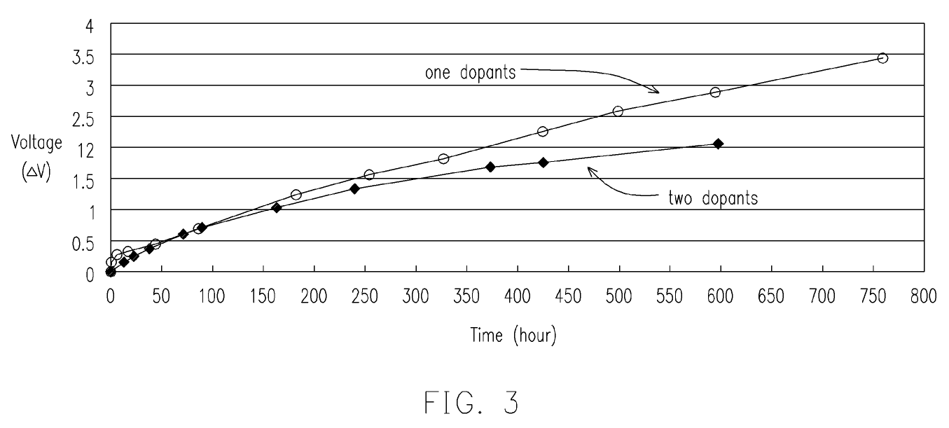

As mentioned above, the organic electroluminescent device 200 of the present invention uses the blue luminescent layer 230 having the first dopant 234 and the second dopant 236 to improve luminescent efficiency, life time and brightness thereof. Because of the combination of the first dopant 234 and the second dopant 236, the light generated from the blue luminescent layer 230 will not decay after a long-time use. The experimental result is shown in FIG. 3.

Additionally, the blue light generated from the combination of the host 232 and the second dopant 236 is weak. In order to avoid the weakness of the blue light generated from the organic electroluminescent device 200, the weight percentage of the first dopant 234 within the blue luminescent layer 230 is more than the second dopant 236. The first dopant 234 is from about 0.01% to about 50% by weight, and is preferably from about 0.1% to about 10% by weight. The light generated therefrom has a peak wavelength from about 400 nm to about 470 nm. The second dopant is from about 0.01% to about 50% by weight, and is preferably from about 0.1% to about 10% by weight. The light generated therefrom has a peak wavelength from about 420 nm to about 490 nm.

In addition, an absorption wavelength of the second dopant 236 is shorter than an emitting wavelength of the first dopant 234. Therefore, the light generated form the first dopant 234 will not be absorbed by the second dopant 236 for avoiding the reduction of luminescent efficiency of the organic electroluminescent device 200.

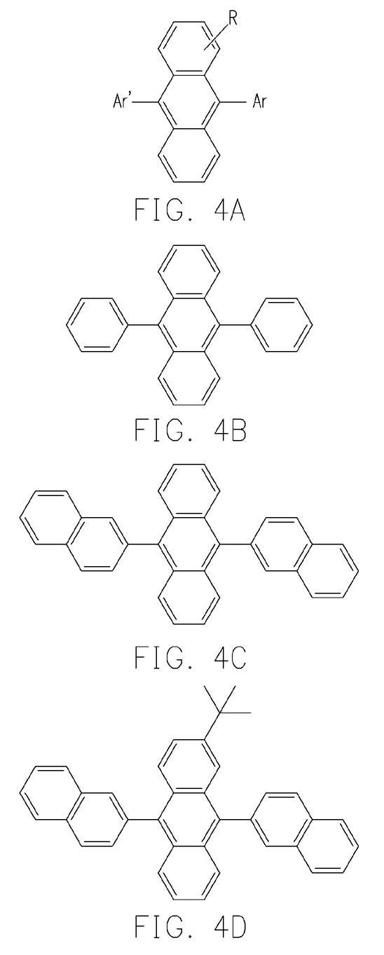

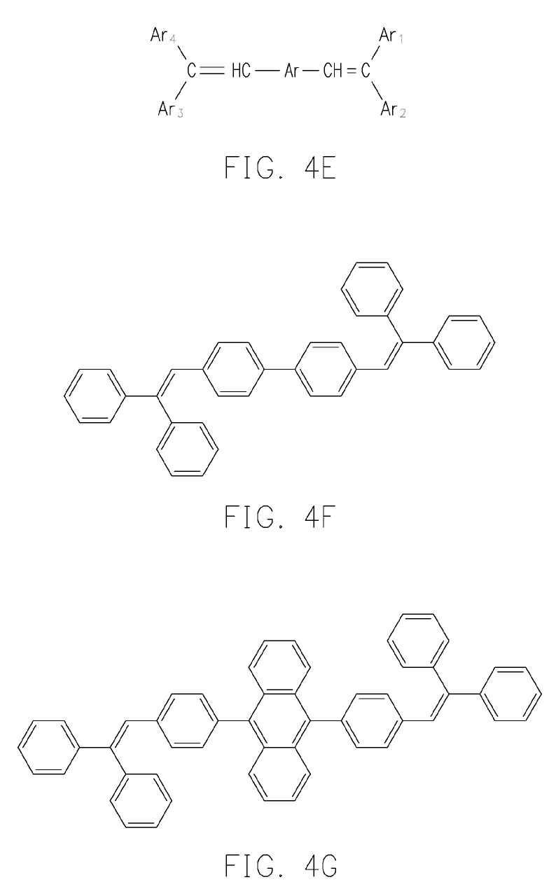

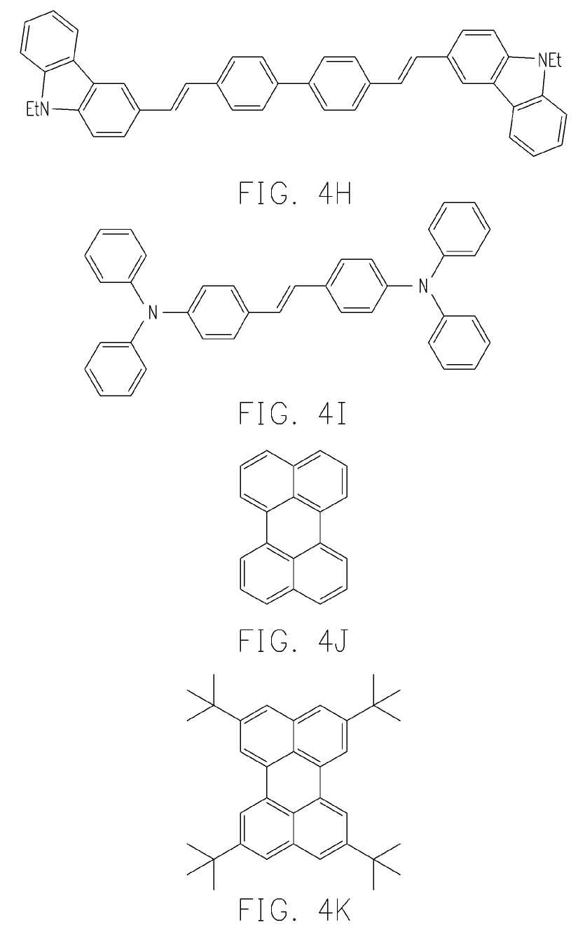

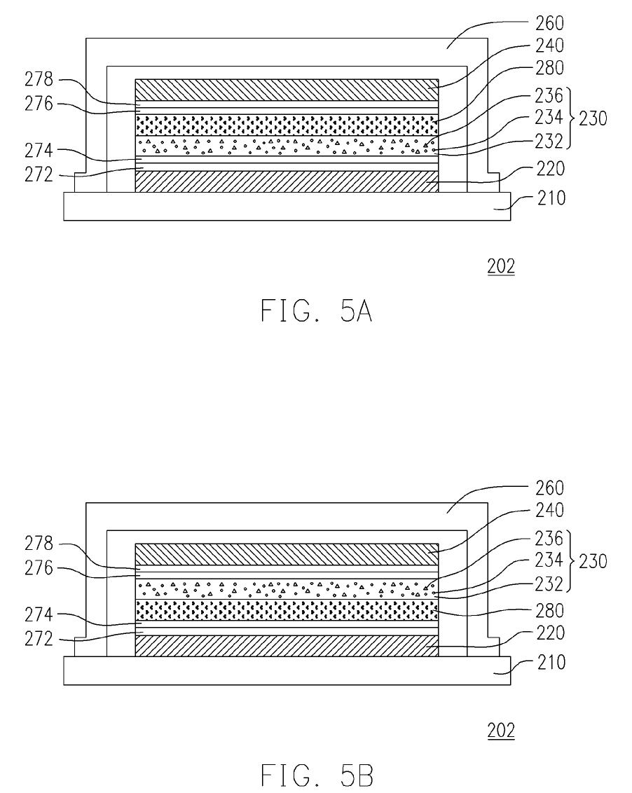

As to the material of the host 232, the first dopant 234 and the second dopant 236, the host 232 can be, for example, 9,10-diarylanthracene as shown in FIG. 4A, wherein Ar and Ar′ are aryl, R is hydrogen, alkyl or aryl, such as 9,10-diphenylanthracene (DPA); 9,10-bis(2-naphthalenyl)anthracene (ADN); or 2-(1, 1-dimethyl)-9,10-bis(2-naphthalenyl)anthracene, (TBADN) shown in FIGS. 4B-4D respectively. The host 232 also can be distyrylarylene (DSA) as shown in FIG. 4E, wherein Ar, Ar1, Ar2, Ar3, Ar4 are arkyl, such as DPVBi or 9,10-bis[4-(2,2-diphenylethenyl)phenyl] anthracene shown in FIGS. 4F and 4G respectively. The first dopant 234 can be, for example, amino substituted distyrylarylene (DSA-amine) as shown in FIGS. 4H and 4I. The second dopant can be, for example, perylene compound as shown in FIGS. 4J and 4K.

Additionally, the organic electroluminescent device 200 further comprises a cover plate 260 which is, for example, over the cathode 240 for packaging the device.

In the present invention, the current applied to the organic electroluminescent device 200 can be AC, DC or pulse current. Additionally, the light generated from the organic electroluminescent device 200 can go through the anode 220 or the cathode 240.

Referring to FIG. 2, the organic electroluminescent device 200 further comprises a hole injecting layer (HIL) 272, a hole transporting layer (HTL) 274, an electron transporting layer (ETL) 276 and an electron injecting layer (EIL) 278. The HIL 272 is, for example, between the anode 220 and the blue luminescent layer 230 and the HTL 274 is, for example, between the blue luminescent layer 239 and the HIL 272. Moreover, the ETL 276 is, for example, between the blue luminescent layer 230 and the cathode 240, and the EIL 278 is, for example, between cathode 240 and the ETL 276.

Referring to FIG. 2, the method of fabricating the first preferred organic electroluminescent device 200 is described as following. The anode 220 is formed on the substrate 210. The blue luminescent layer 230 is then formed on the anode layer 220 by evaporation or coating. The blue luminescent layer 230 comprises: a host 232, a first dopant 234 and a second dopant 236. The first and second dopants 234 and 236 respectively are doped within the host 232. The cathode 240 is formed on the blue luminescent layer 230. Additionally, the method of forming the anode 220 and the cathode 240 is, for example, evaporation or sputtering.

Additionally, the method fabricating the first preferred organic electroluminescent device 200 of the present invention further comprises forming the HIL 272 and the HTL 274 after forming the anode 220 and before forming the blue luminescent layer 230. After forming the blue luminescent layer 230 and before forming the cathode 240, the method further comprises forming the ETL 276 and the EIL 278. The HIL 272, HTL 274, ETL 276 and EIL 278 can be formed, for example, by performing vacuum deposition or spin-coating.

FIGS. 5A and 5B are schematic cross-sectional views showing an organic electro-luminance device according to a second preferred embodiment of the present invention. It is a white light organic electroluminescent device. Referring to FIGS. 5A and 5B, the second embodiment forms an orange-red luminescent layer 280 on or below the blue luminescent layer 230 within the structure of the first embodiment. The other structure and the fabricating method thereof are similar to those of the first embodiment, and therefore a detail descriptions thereof are not repeated herein. Because the blue light generated form the blue luminescent layer 230 will be complementary to the orange-red light generated from the orange-red luminescent layer 280 for generating white light, the application of the organic electroluminescent device 202 is extended.

Moreover, because of the combination of the first dopant 234 and the second dopant 236 within the blue luminescent layer 230, the organic electroluminescent device 202 has high luminescent efficiency, long lifetime and high brightness. Further, the chromatic aberration of white light caused by the decay of blue luminescent layer 230 can be reduced as well.

Accordingly, the organic electro-luminance device and the fabricating method thereof of the present invention utilize two dopants in the blue luminescent layer to the blue light having excellent performance, such that, the brightness and luminescent efficiency of electroluminescent device are further increased. Moreover, the lifetime of blue luminescent layer is promoted, and the white light chromatic aberration of organic electroluminescent device can be avoided or substantially reduced.

Although the present invention has been described in terms of exemplary embodiments, it is not limited thereto. Rather, the appended claims should be constructed broadly to include other variants and embodiments of the invention which may be made by those skilled in the field of this art without departing from the scope and range of equivalents of the invention.

1. An organic electroluminescent device, comprising:
an anode, over a substrate;
a cathode, over the anode;
a blue luminescent layer, between the anode and the cathode, the blue luminescent layer comprising:
a host;
a first dopant, doped within the host; and
a second dopant, doped within the host, the light wavelength generated by the second dopant is different from the light wavelength generated by the first dopant.

2. The organic electroluminescent device of claim 1, wherein a weight percentage of the first dopant within the blue luminescent layer is more than that of the second dopant.

3. The organic electroluminescent device of claim 2, wherein the first dopant within the blue luminescent layer is from about 0.01% to about 50% by weight, which generates a light having a peak wavelength from about 400 nm to about 470 nm.

4. The organic electroluminescent device of claim 2, wherein the second dopant within the blue luminescent layer is from about 0.01% to about 50% by weight, which generates a light having a peak wavelength from about 420 nm to about 490 nm.

5. The organic electroluminescent device of claim 1, wherein an absorption wavelength of the second dopant is shorter than an emitting wavelength of the first dopant.

6. The organic electroluminescent device of claim 1, wherein the first dopant includes amino substituted distyrylarylene.

7. The organic electroluminescent device of claim 1, wherein the second dopant includes perylene compound.

8. The organic electroluminescent device of claim 1, further comprising an orange-red luminescent layer between the anode and the blue luminescent layer.

9. The organic electroluminescent device of claim 1, further comprising an orange-red luminescent layer between the cathode and the blue luminescent layer.

10. A method of fabricating an organic electroluminescent device, comprising:
forming an anode on a substrate;
forming a blue luminescent layer on the anode, wherein the blue luminescent layer comprises:
a host;
a first dopant, doped within the host;
a second dopant, doped within the host, the light wavelength generated by the second dopant is different from the light wavelength generated by the first dopant; and
forming a cathode on the blue luminescent layer.

11. The method of fabricating an organic electroluminescent device of claim 10, wherein a weight percentage of the first dopant within the blue luminescent layer is more than that of the second dopant.

12. The method of fabricating an organic electroluminescent device of claim 11, wherein the first dopant within the blue luminescent layer is from about 0.1% to about 10% by weight, which generates light having a peak wavelength from about 400 nm to about 470 nm.

13. The method of fabricating an organic electroluminescent device of claim 11, wherein the second dopant within the blue luminescent layer is from about 0.1% to about 10% by weight, which generates light having a peak wavelength from about 420 nm to about 490 nm.

14. The method of fabricating an organic electroluminescent device of claim 10, wherein an absorption wavelength of the second dopant is shorter than an emitting wavelength of the first dopant.

15. The method of fabricating an organic electroluminescent device of claim 10, wherein the first dopant includes amino substituted distyrylarylene.

16. The method of fabricating an organic electroluminescent device of claim 10, wherein the second dopant includes perylene compound.

17. The method of fabricating an organic electroluminescent device of claim 10, further comprising forming an orange-red luminescent layer between the anode and the blue luminescent layer.

18. The method of fabricating an organic electroluminescent device of claim 10, further comprising forming an orange-red luminescent layer between the cathode and the blue luminescent layer.
